(19) United States
(12) Patent Application Publication
(10) Pub. No.: US 2018/0135345 A1
(43) Pub. Date: May 17, 2018

(54) TAILGATE SENSOR

(71) Applicant: Vermeer Manufacturing Company, Pella, IA (US)

(72) Inventors: Jacob Limke, Pella, IA (US); Willem Jacobus Reijersen van Buuren, Dirksland (NL); Ty Hartwick, Pella, IA (US); Philip Robert Lane, Pella, IA (US); Kent Thoreson, Bussey, IA (US)

(21) Appl. No.: 15/352,910

(22) Filed: Nov. 16, 2016

(51) Int. Cl. E05F 15/70

(52) U.S. Cl. CPC E05F 15/70; A01F 15/0883

(57) ABSTRACT

The round baler includes a frame and a tailgate pivotally mounted to the frame via a tailgate pivot axis. The tailgate is movable along a path of travel range between an open position and a closed position. When in the open position, a bale can be discharged from the baler and, when in the closed position, a bale is prevented from being discharged from the baler. The baler also includes a sensor that has a sensor axis. This sensor is mounted to the baler with the sensor axis approximately coaxial with the tailgate pivot axis. An operating portion of the sensor is operatively directly movable with the tailgate. The sensor has a mechanical rotary range that is at least the travel range of the tailgate; and an electrical sensing range. The electrical sensing range is less than both the mechanical rotary range and the travel range of the tailgate.

### BACKGROUND

Round balers have become an integral part of the agricultural industry and a variety of different types of balers are currently in use. Balers can be either towed behind a tractor or be self-propelled. Balers often either use a system of belts that compress the bale or a system that includes a fixed chamber to form the bale. A wrap material is then applied to the finished round bale to aid in securing the bale. Typically after a bale is formed and wrapped, a tailgate will be opened and the bale will be ejected from the baler. During operation of the baler, it is desirable to open and close the tailgate as fast as possible to minimize the bale forming cycle time, thereby allowing the operator to become more efficient. However, it is also undesirable to slam the tailgate open and closed.

Therefore, improvements in tailgate sensing and operation are needed.

### SUMMARY

The present disclosure relates generally to sensing the rotary position of a tailgate of a round baler as it rotates about its tailgate pivot axis, with a specific sensor that is not developed for this specific purpose, wherein the performance of that sensor is not optimized for this purpose. The sensor has a sensing range that is less than the complete rotary path of travel of the tailgate, and thus it is not an obvious design choice for this application. However, the sensor does have a mechanical rotary range of movement that is more than the rotary movement of the tailgate. Although this sensor is not able to measure the position of the tailgate throughout the complete path of travel of the tailgate, there is a motivation to utilize it for this purpose due to significant advantages in its cost and reliability. The present disclosure describes a method for utilizing this specific type of sensor to produce acceptable results.

In one example, a round baler is disclosed. The round baler includes a frame and a tailgate pivotally mounted to the frame with a tailgate pivot axis. The tailgate is movable along a path of travel range between an open position and a closed position. When in the open position, a bale can be discharged from the round baler and, when in the closed position, a bale is prevented from being discharged from the round baler. The baler also includes a sensor that has a sensor axis. This sensor is mounted to the baler with the sensor axis approximately coaxial with the tailgate pivot axis. An operating portion of the sensor is operatively connected for direct movement with the tailgate. The sensor has a mechanical rotary range that is more than the path of travel range of the tailgate and an electrical sensing range. The electrical sensing range is less than the mechanical rotary range and also less than the path of travel range of the tailgate.

In another example, a round baler is disclosed. The round baler includes a frame and a tailgate for allowing bales to be discharged from the baler. The tailgate is adapted to pivot about a tailgate pivot axis relative to the frame through a tailgate range of pivotal movement. The round baler includes a rotary sensor that includes a sensor housing and a sensor rotary member that is mounted within the sensor housing. The sensor housing and the sensor rotary member are rotatable relative to one another about a sensor axis of rotation. The rotary sensor has a mechanical range of rotary movement between the sensor housing and the sensor rotary member. The rotary sensor has a sensed range of rotary movement between the sensor housing and the sensor rotary member. The mechanical range of rotary movement is greater than the sensed range of rotary movement. The mechanical range of rotary movement is equal to or greater than the tailgate range of pivotal movement. The sensed range of rotary movement is less than the tailgate range of pivotal movement. The rotary sensor is mounted with the sensor axis of rotation generally coaxially aligned with the tailgate pivot axis. The sensor housing is coupled to one of the frame and the tailgate, and the sensor rotary member is coupled to the other of the frame and the tailgate. The rotary sensor is mounted such that the rotary sensor and the tailgate rotate together at a one-to-one ratio as the tailgate moves through the tailgate range of pivotal movement. The rotary sensor mechanically rotates with the tailgate throughout the entire tailgate range of pivotal movement.

In one example, the sensor is used to sense the position of the tailgate along the lower portion of travel, but not the upper portion of travel.

In one example, the sensor is used to sense the position of the tailgate along the upper portion of travel, but not the lower portion of travel.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic side view of an example round baler with a tailgate in a closed position, according to one embodiment of the present disclosure;

FIG. 2 illustrates a schematic side view of the round baler of FIG. 1 with the tailgate in the open position;

FIG. 3 illustrates an example rotary sensor, according to one embodiment of the present disclosure;

FIG. 4 illustrates a schematic representation of a tailgate pivot arrangement including a shaft, according to one embodiment of the present disclosure;

FIG. 5 illustrates a schematic representation of a tailgate pivot arrangement, according to one embodiment of the present disclosure;

FIG. 6 illustrates a schematic diagram of a portion of a path of travel range and an example sensed range of the tailgate of the round baler of FIG. 1, according to one embodiment of the present disclosure;

FIG. 7 illustrates a schematic diagram of a portion of a path of travel range and an example sensed range of the tailgate of the round baler of FIG. 1, according to one embodiment of the present disclosure; and

FIG. 8 illustrates a schematic diagram of a portion of a path of travel range and an example sensed range of the tailgate of the round baler of FIG. 1, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The round baler disclosed herein has several advantages. Specifically, the round baler uses a tailgate position sensor that is cost effective and reliable. The tailgate sensor is produced in mass quantities and has proven to have a long life span. The tailgate position sensor allows the round baler to monitor the position of the tailgate over a limited range of movement of the tailgate so as to allow the round baler to more efficiently operate (e.g., reducing baling cycle times).

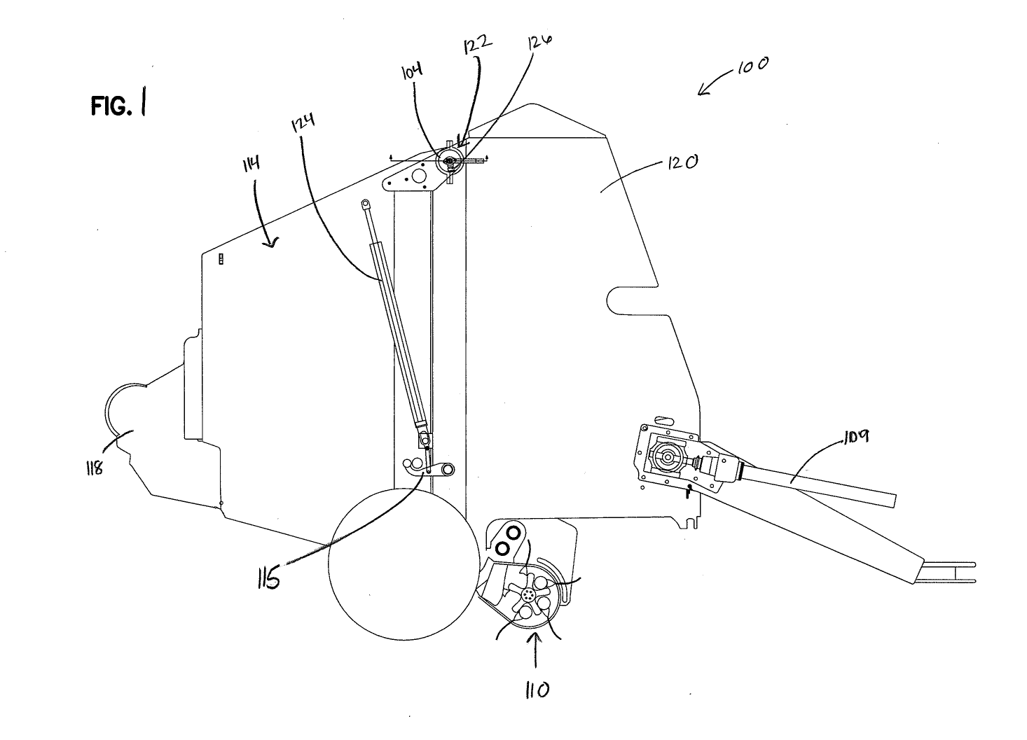

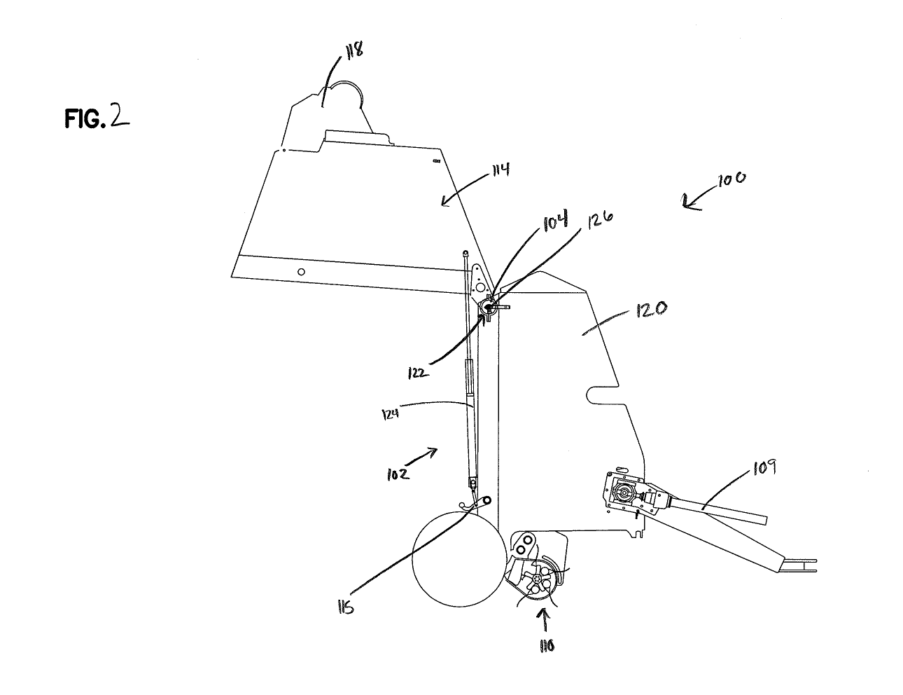

FIGS. 1 and 2 show schematic side views of a round baler 100. In accordance with the principles of the present disclosure, the round baler 100 uses an expandable baling chamber 102 which operates by utilizing a series of bale forming belts routed around a series of rollers. Alternatively, a single bale forming belt may be utilized. Further, a fixed baling chamber may also be utilized.

The baler 100 includes a driving means 109, a pick-up device 110, and a tailgate 114. As material is picked up by the pick-up device 110 and deposited in the baling chamber 102, the material is compressed into a bale. Once a full bale is formed, the bale is wrapped by a wrapping device 118. The wrapping device 118 is configured to apply a layer of wrap material to the outer circumference of the full bale. Once the wrapping sequence is completed, the operator ejects the full bale from the baling chamber 102 by moving the tailgate 114 from a closed position, as shown in FIG. 1, to an open position, as shown in FIG. 2. Further details relating to the baling operation within the baling chamber can be found in U.S. Pat. No. 7,181,900, which is hereby incorporated by reference in its entirety.

In the depicted embodiment, the tailgate 114 is pivotally attached to a main frame 120 of the baler 100 at a tailgate pivot 122 by way of a pivot tube 104. In some embodiments, a linkage is connected between the main frame 120 and the tailgate 114. Specifically, the tailgate pivot 122 is shown to be positioned on the main frame 120. When in the closed position, the tailgate 114 is latched to the main frame 120 of the baler 100 via a latch 115. Movement of the tailgate 114 is controlled by a tailgate actuator 124, such as a hydraulic actuator. In some embodiments, the baler 100 includes a plurality of tailgate actuators 124 for controlling the movement of the tailgate 114. In some embodiments, the tailgate actuator(s) 124 is/are in communication with a controller 127 used to control the operation of the baler 100.

Referring generally to the controller 127 and methods of controlling, and referring in particular to computing systems embodying the methods and systems of the present disclosure, it is noted that various computing systems can be used to perform the control processes disclosed herein. For example, embodiments of the disclosure may be practiced in various types of electrical circuits comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including, but not limited to, mechanical, optical, fluidic, and quantum technologies. In addition, aspects of the methods described herein can be practiced within a general purpose computer or in any other circuits or systems.

As the tailgate 114 is rotated about the tailgate pivot 122, the tailgate actuator 124 supports the weight of the tailgate 114. During a baling operation, it is desirable to open and close the tailgate quickly to minimize the cycle time. This process includes 1) releasing the tailgate latch 115; 2) raising the tailgate 114 from the closed to the open position; 3) lowering the tailgate 114 from the open to the closed position; and 4) closing the tailgate latch 115. The tailgate 114 includes a sensor 126 to measure a position of the tailgate 114.

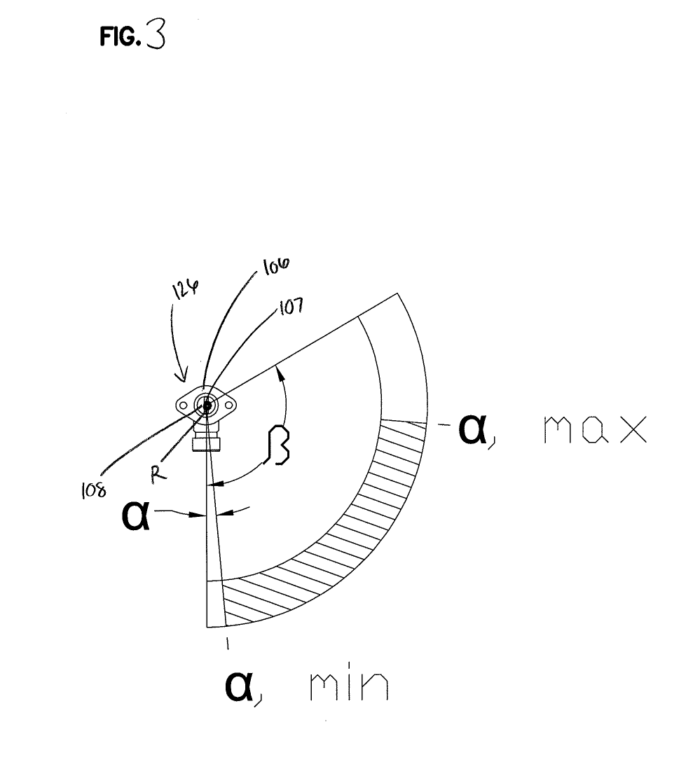

FIG. 3 shows a front view of an example sensor 126. The sensor 126 is a rotary sensor. In some embodiments, the sensor 126 is a rotary transducer, such as a rotary potentiometer. The sensor 126 includes a housing 106 and a rotatable member 108 mounted within the housing 106, wherein this assembly has a sensor axis of rotation R. The rotatable member 108 is illustrated to have a drive slot 107. The sensor 126 can be a non-contact angular position sensor, such as a CHERRY AN1 sensor. An angular position sensor is described in U.S. Pat. No. 6,960,973, which is hereby incorporated by reference in its entirety. Such a sensor provides a linear change in voltage output to the controller 127 that corresponds to an angular rotation of the rotatable member 108. Common uses for the sensor 126 include, but are not limited to, throttle and valve position sensing, pedal position sensing, joystick position sensing, and gear position sensing.

As the rotatable member 108 rotates about the housing 106, the sensor 126 senses the relative position of the rotatable member 108 with respect to the housing 106. The rotatable member 108 has a mechanical travel range that rotatable member 108 can rotate within the housing 106, represented by angle β. In some embodiments, the mechanical travel range is about 120 degrees with respect to the housing 106. However, the sensor 126 is configured to only sense the movement of the rotatable member 108 over a range that is less than the mechanical travel range, angle β. Angle α represents the position of the rotatable member 108 within the housing 106. The electrical sensing range for the sensor is represented by the cross-hatched area between the angle α,min in which the rotatable member 108 is moved a small amount from a position where it is spring-biased against an internal stop to define a starting angle, and the angle α,max.

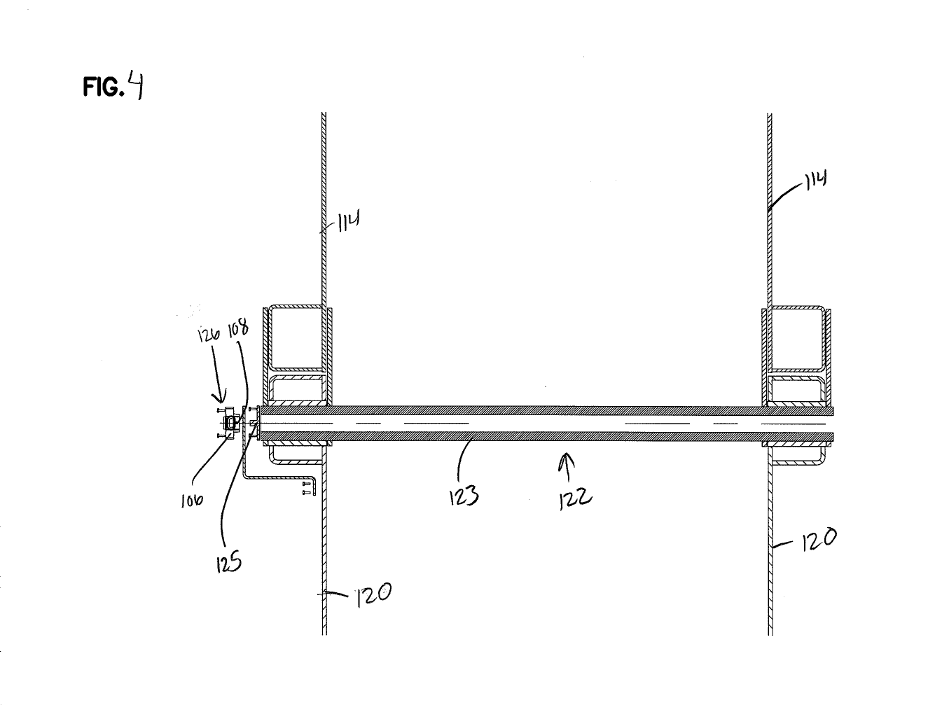

FIG. 4 shows a schematic top view of a cross-section of the baler 100. FIG. 4 further shows the mounting of the sensor 126 to the baler 100, according to one embodiment of the present disclosure. As shown, the tailgate 114 is pivotally attached to the main frame 120 at the tailgate pivot 122. In the depicted embodiment, the tailgate pivot 122 includes a shaft 123 that rotates with the tailgate 114 about the main frame 120. The sensor 126 is positioned at the tailgate pivot 122. Specifically, the housing 106 of the sensor 126 is mounted to the main frame 120 in a position where the sensor axis of rotation is generally aligned with the axis of rotation of the shaft 123. The rotatable member 108 is drivably engaged with the shaft 123. In the embodiment shown in FIG. 4, drive adaptor 125 is configured with a tab that fits into the drive slot 107 of the rotatable member 108. The housing 106 is set in a rotational position where the tab of the drive adaptor will rotate through its range of motion as the tailgate 114 moves between the closed and open positions. That rotational position is within the range of mechanical travel of the sensor 126. Therefore, as the tailgate 114 moves between the open and closed positions, the shaft 123 rotates, which then rotates the rotatable member 108 of the sensor 126.

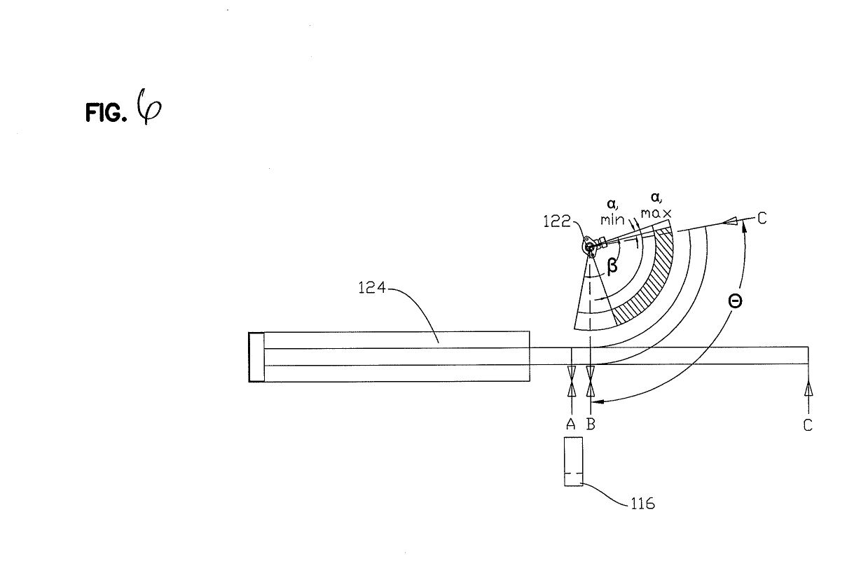

The sensor 126 is configured to measure the angular position of the tailgate 114 by sensing the position of the rotatable member 108 with respect to the housing 106, where the housing 106 is fixed to the main frame 120. Then sensor 126 provides such measurements to the controller 127. The controller 127 is configured to aid in controlling the operation of the baler 100, specifically the tailgate 114, using the measurements provided by the sensor 126. While the rotatable member 108 of the sensor 126 is configured to move with the tailgate 114 along the sensor's mechanical travel range, the sensor 126 is capable of measuring the angular the position of the tailgate 114 along only a portion of that movement. Specifically, the sensor 126 can only sense the position of the tailgate 114 when the angle α is within its electric sensing range as shown in FIG. 3. This will be explained in more detail with respect to FIGS. 6-8.

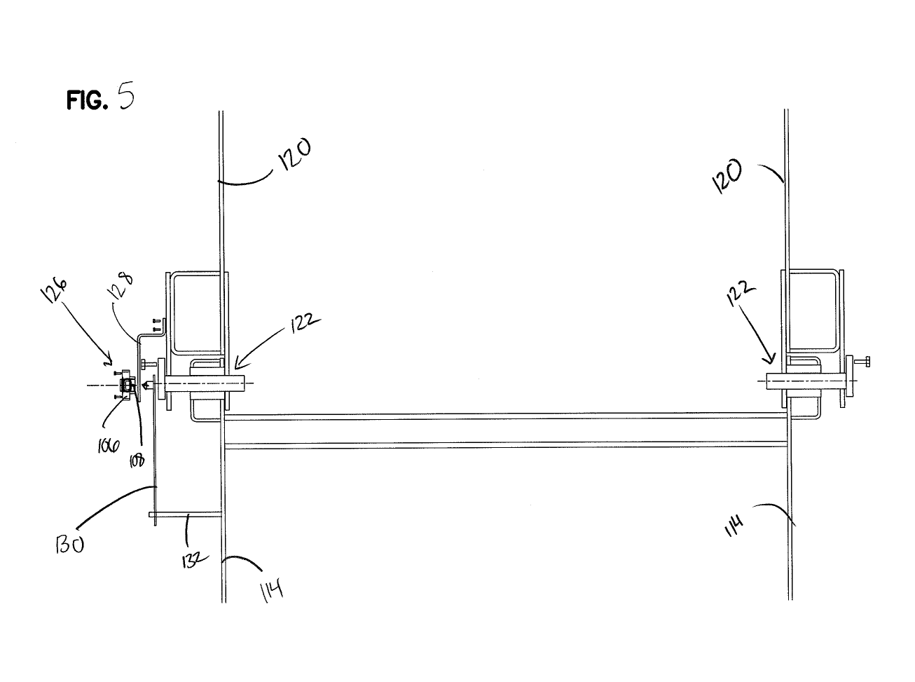

FIG. 5 shows another schematic top view of an example cross-section of the baler 100. In the depicted embodiment, the tailgate pivot 122 is fixed to the main frame 120 of the baler 100. As shown, the sensor 126 is shown slightly separated from its permanent mounting location, thereby showing a partially exploded view of its mounting components. Specifically, the housing 106 of the sensor 126 is configured to be attached to the main frame 120 by way of a bracket 128. The rotatable member 108 is configured to be drivably engaged with the tailgate 114 by way of a sensor arm 130. The sensor 126 is mounted so that the rotatable member 108 is generally aligned with the axis of rotation of the tailgate pivot 122. The sensor arm 130 is configured to be effectively attached to the sensor 126 through the engagement of a tab that engages with the drive slot 107 of the rotatable member 108. The sensor arm 130 is engaged with the tailgate 114 at a drive extension 132, which is fixed to the tailgate 114 and with a slot in the sensor arm 130. Therefore, as the tailgate 114 rotates between the open and closed positions, the drive extension 132 rotates with the tailgate 114 about its axis of rotation, causing the sensor arm 130 to rotate with the rotatable member 108 of the sensor 126 about the sensor's axis of rotation R. Because the housing 106 of the sensor 126 is fixed to the main frame 120 by way of the bracket 128, the sensor 126 can sense the relative position of the tailgate 114 with respect to the main frame 120. The slot in the sensor arm 130 that is engaged with the drive extension 132 of the tailgate 114 provides for some misalignment between the tailgate axis of rotation and the sensor axis of rotation.

In other embodiments, the tailgate pivot 122 is positioned on the tailgate 114 and, therefore, the sensor 126 is positioned on the tailgate 114. Specifically, the rotatable member 108 can be attached to the main frame 120 by the sensor arm 130, and the housing 106 of the sensor 126 can be mounted to the tailgate 114.

FIG. 6 shows a schematic diagram of the portion of a path of travel range of the tailgate 114 that the sensor 126 is configured to measure, according to one embodiment of the present disclosure. The tailgate 114 is shown to move about the tailgate pivot 122, thereby having a path of travel range that corresponds with an angular position range represented by an angle θ. In some embodiments, the angle θ is greater than 90 degrees. In some embodiments, the angle θ is about 120 degrees.

The tailgate actuator 124 is shown to be positionable between points A, B, and C. At point A, the tailgate 114 is in a latched, closed position. At point B, the tailgate actuator 124 travels a distance to disengage the tailgate latch 115, thereby positioning the tailgate 114 in an unlatched, closed position. When extending from point B to point C, the tailgate 114 rotates from the closed position, corresponding to point B, to the open positon, corresponding to point C.

The sensor 126 is shown with its axis coaxially aligned with the tailgate pivot axis, and the sensor housing 106 rotated to a position wherein its sensing range, which corresponds with the shaded region, is positioned so that when the angle α is at the smallest angle of 5 degrees as shown, it is positioned higher than point C which represents the highest position of the tailgate. Thus, the sensor 126 is capable of measuring the angular position of the tailgate 114 at the open position, point C, but it is not capable of measuring the angular positon of the tailgate 114 at the closed position, point B. As the tailgate moves through its range of motion represented by the angle θ, the sensor will move through that same range of travel, wherein the magnitude of that angular travel will result in an angle α that is beyond the sensing range of the sensor 126. The sensing range of sensor 126 overlaps or coincides with an upper portion of the tailgate path of travel range and does not include a lower portion of the tailgate path of travel range. The tailgate 114, therefore, has a sensed range of movement where the angular position of the tailgate is sensed; and a non-sensed range of movement where the angular position of the tailgate 114 is not sensed. In one example, the sensed range covers at least 45, 60, 75, or 90 degrees, and the non-sensed range covers at least 10, 15, 20, or 25 degrees.

With this mounting arrangement, the lower portion of travel of the tailgate 114 will not be detected by the sensor 126. The process would include moving the tailgate 114 by extending the tailgate actuator 124 at full speed from the closed position toward the open position. The lower portion of that travel will be an open-loop control and therefore no feedback will be provided by the sensor 126 until the tailgate 114 moves into the sensor 126's sensing range. As the tailgate 114 approaches the open position, the speed can be reduced before the tailgate 114 is stopped at any desired position within the sensing range of the sensor 126.

When closing the tailgate 114 by retracting the tailgate actuator 124, the tailgate 114 moves from an open position toward the closed position. A portion of closing movement is measurable by the sensor 126, corresponding to that portion where the measured angle α is within the cross-hatched sensing range. However, as the tailgate 114 approaches the closed position, the sensor 126 would not be capable of measuring that movement as the tailgate 114 will eventually have an angular position outside of the sensing range. The process can include moving the tailgate 114 at full speed from the open position until the end of the sensing range of the sensor 126. The speed of movement of the tailgate 114 can be reduced at the point in time when the tailgate 114 has an angular position that corresponds to the end of the sensing range of the sensor 126. As the tailgate 114 continues to move toward the closed position, the system would be operating in an open-loop control. In some embodiments, in order to ensure that the tailgate 114 is completely closed, which is important for the operation of the baler 100, the controller 127 could utilize a position sensor 116 (e.g., proximity sensor, contact sensor, or other like sensor) for the tailgate latch 115, to detect when the latch 115 is closed. In the some embodiments, the tailgate latch 115 is operated by the tailgate actuators 124 (as shown in FIGS. 1 and 2 for instance), so the system can continue to retract the tailgate cylinder at the reduced speed until the system detects that the latch 115 is in the locked position.

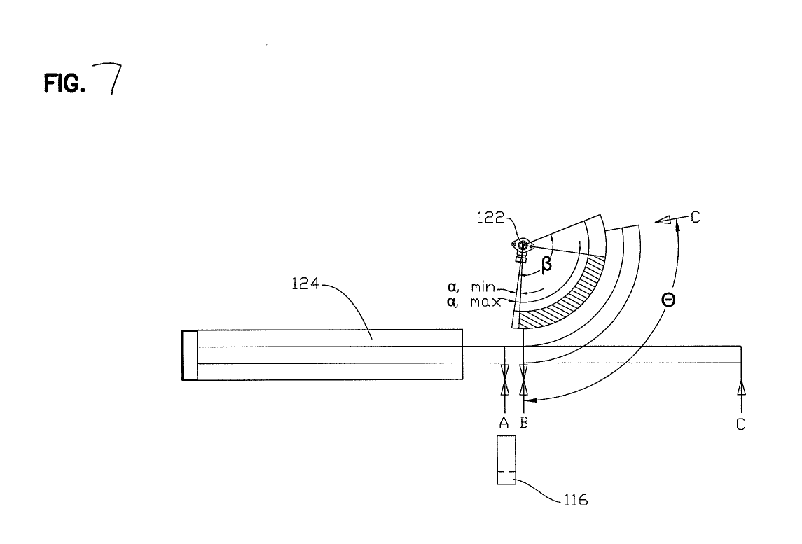

FIG. 7 shows a schematic diagram of a portion of the path of travel range of the tailgate 114 that the sensor 126 is capable of measuring, according to one embodiment of the present disclosure. The sensor 126 is illustrated to have a sensing range, which corresponds with the angular position range represented between an angle α,min and α,max, wherein the sensor 126 is positioned so that this sensing range is capable of measuring the angular position of the tailgate 114 at the closed position, point B, but it is not capable of measuring the angular positon of the tailgate 114 at the open position, point C. The sensing range of the sensor 126 overlaps or coincides with a lower portion of the path of travel range of the tailgate 114 and does not include an upper portion of the path of travel range of the tailgate 114. Therefore, the sensing range, corresponding to the angular position range represented by the cross-hatched area between angle α,min and α,max is oppositely shifted along the path of travel range of the tailgate 114 as compared to the embodiment discussed with relation to FIG. 6. The magnitude of angle θ remains greater than the magnitude of angle α. In other embodiments, the sensed range is offset from the upper portion of the path of travel of the tailgate 114 and offset from the lower portion of the path of travel of tailgate 114.

With this mounting arrangement, the last portion of travel of the tailgate 114 when moving from the closed to the open position will not be detected by the sensor 126. The process would include moving the tailgate 114 by extending the tailgate actuator 124 at full speed from the closed position toward the open position. The first portion of that travel will be a closed-loop control, providing position feedback to the sensor 126 until the tailgate 114 moves out of the sensor 126's sensing range. As the tailgate 114 approaches the open position and moves to the range of travel outside of the sensor's sensing range, the speed can be reduced.

When closing the tailgate 114, the first portion of travel of the tailgate 114 will not be detected by the sensor 126. The process would include moving the tailgate 114 by retracting the tailgate actuator 124 at full speed from the open position. The first portion of that travel will be an open-loop control and therefore no feedback will be provided by the sensor 126 until the tailgate 114 moves into the sensor 126's sensing range. As the tailgate 114 approaches the closed position, the speed can be reduced before the tailgate 114 reaches the closed position, point B. When reaching the closed position, point B, the tailgate 114 can again be moved at full speed so as to allow the tailgate 114 to properly engage and close the latch 115.

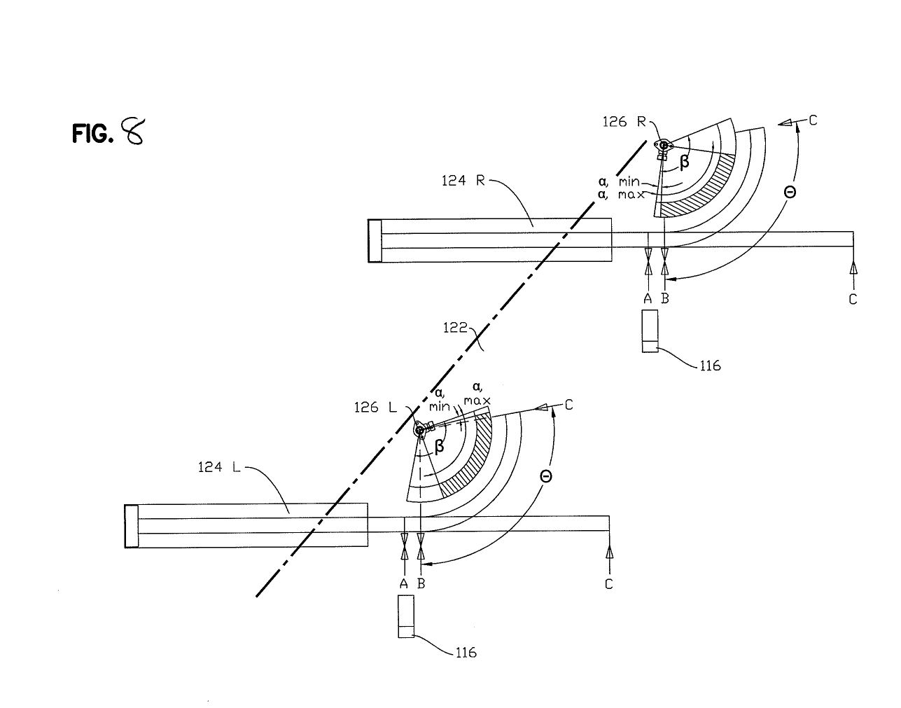

FIG. 8 shows a schematic isometric diagram of the path of travel range of the tailgate 114 that would be moved with a first cylinder 124L on the left side of the baler 100 and a second cylinder 124R on the right side, with a plurality of sensors 126L, 126R for measuring the position of the tailgate 114, according to one embodiment of the present disclosure. Because the sensors 126 have a limited measuring range, a pair of identical sensors 126L,126R can be utilized and positioned so as to be able to sense the position of the tailgate 114 along a wider range of the path of travel range of the tailgate 114. As illustrated, the sensors 126L, 126R are positioned such that their sensing ranges overlap. This allows the sensor 126L to be capable of measuring the angular position of the tailgate 114 at the open position, point C, and sensor 126R to be capable of measuring the angular position of the tailgate 114 at the closed position, point B. Therefore, the sensing range is a combination of the embodiments described herein with respect to FIGS. 6 and 7.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A round baler comprising:
a frame;
a tailgate including a tailgate pivot axis, the tailgate being pivotally mounted to the frame about the tailgate pivot axis, the tailgate being movable along a path of travel range between an open position and a closed position, wherein, when in the open position, a bale can be discharged from the round baler, and wherein, when in the closed position, a bale is prevented from being discharged from the round baler; and
a sensor having a sensor axis mounted to the baler such that the sensor axis is approximately coaxial with the tailgate pivot axis, and wherein an operating portion of the sensor is operatively connected with the tailgate, the operating portion of the sensor being configured for direct movement with the tailgate, wherein the sensor has a mechanical rotary range and an electrical sensing range, the mechanical rotary range being at least the path of travel range of the tailgate, the electrical sensing range being less that the mechanical rotary range and also less than the path of travel range of the tailgate.

2. The round baler of claim 1, wherein the tailgate defines a path of travel angle that is defined by the open position and the closed position, the path of travel angle being greater than or equal to 90 degrees.

3. The round baler of claim 2, wherein the sensor has a sensing range defined along the path of travel of the tailgate, wherein the sensing range has a sensing angle of less than or equal to 90 degrees.

4. The round baler of claim 1, wherein the sensor has a sensing range that coincides with an upper portion of the tailgate path of travel range and does not include a lower portion of the tailgate path of travel range.

5. The round baler of claim 1, further comprising a second sensor attached to the tailgate, wherein the second sensor has a mechanical rotary range and an electrical sensing range, wherein the electrical sensing range is less that the mechanical rotary range of the second sensor and also less than the path of travel range of the tailgate, wherein the second sensor has a sensing range that includes a lower portion of the tailgate path of travel range and does not include an upper portion of the tailgate path of travel range.

6. The round baler of claim 1, wherein the sensor has a sensing range that includes a lower portion of the tailgate path of travel range and does not include an upper portion of the tailgate path of travel range. (Currently Amended) A system for controlling a tailgate comprising:
a tailgate including a tailgate pivot, the tailgate being pivotally mounted to a frame of a round baler about the tailgate pivot, the tailgate being pivotally mounted for movement through a path of travel range defined by a closed position at a first angular position and a fully open position at a second angular position, the second angular position being spaced from the first angular position;
a sensor being mounted to the tailgate at the tailgate pivot, the sensor having a sensing range of less than the tailgate path of travel range;
an actuator for moving the tailgate between the closed position and the open position; and
a control system in communication with the sensor, the control system having logic to control the movement of the tailgate based on a sensor measurement.

8. The system of claim 7, wherein the control system uses closed-loop positional feedback from the sensor when the tailgate is moved from the closed position towards the fully open position, and wherein the control system receives open-loop positional feedback from the sensor when the tailgate is moved from the open position to the closed position.

9. A baler comprising:
a frame and a tailgate for allowing bales to be discharged from the baler, the tailgate being adapted to pivot about a tailgate pivot axis relative to the frame, the tailgate being able to pivot through a tailgate range of pivotal movement;
a rotary sensor including a sensor housing and a sensor rotary member, the sensor rotary member being mounted within the sensor housing, the sensor housing and the sensor rotary member being rotatable relative to one another about a sensor axis of rotation, the rotary sensor having a mechanical range of rotary movement between the sensor housing and the sensor rotary member, the rotary sensor having a sensed range of rotary movement between the sensor housing and the sensor rotary member, the mechanical range of rotary movement being greater than the sensed range of rotary movement, the mechanical range of rotary movement being equal to or greater than the tailgate range of pivotal movement, and the sensed range of rotary movement being less than the tailgate range of pivotal movement; and
the rotary sensor being mounted with the sensor axis of rotation generally coaxially aligned with the tailgate pivot axis, the sensor housing being coupled to one of the frame and the tailgate and the sensor rotary member being coupled to the other of the frame and the tailgate, the rotary sensor being mounted such that the rotary sensor and the tailgate rotate together at a one-to-one ratio as the tailgate moves through the tailgate range of pivotal movement, the rotary sensor mechanically rotating with the tailgate throughout the entire tailgate range of pivotal movement.

10. The round baler of claim 1, wherein the sensor has a sensing range that includes an upper portion of the tailgate path of travel range and does not include a lower portion of the tailgate path of travel range.

11. The round baler of claim 1, wherein the mechanical rotary range of the sensor is more than the path of travel range of the tailgate.

12. The round baler of claim 1, further comprising a tailgate latch for selectively coupling the tailgate to the frame, the tailgate latch having a latched position and an unlatched position, wherein, when in the latched position, the latch secures the tailgate to the frame of the round baler when the tailgate is in the closed position, and wherein, when in the , unlatched position, the tailgate is in the open position.

13. The round baler of claim 12, further comprising a position sensor in communication with the tailgate latch and the control system, wherein the position sensor communicates to the control system when the tailgate is in the latched position.

14. The system of claim 7, wherein the sensor has a mechanical rotary range and an electrical sensing range, the mechanical rotary range being at least the path of travel range of the tailgate, the electrical sensing range being less that the mechanical rotary range and also less than the path of travel range of the tailgate.

15. The system of claim 14, wherein the mechanical rotary range of the sensor is more than the tailgate path of travel range.

16. The system of claim 7, wherein the sensor has a sensing range that includes a lower portion of the tailgate path of travel range and does not include an upper portion of the tailgate path of travel range.

17. The system of claim 7, wherein the sensor has a sensing range that includes an upper portion of the tailgate path of travel range and does not include a lower portion of the tailgate path of travel range.

18. The system of claim 7, wherein the sensor measurement of the sensor is a linear change in voltage.

19. The system of claim 7, further comprising a tailgate latch for selectively coupling the tailgate to the frame of the round baler, the tailgate latch having a latched position and an unlatched position, wherein, when in the latched position, the latch secures the tailgate to the frame of the round baler when the tailgate is in the closed position, and wherein, when in the unlatched position, the tailgate is in the open position.

20. The system of claim 19, further comprising a position sensor in communication with the tailgate latch and the control system, wherein the position sensor communicates to the control system when the tailgate is in the latched position.
